(19) United States
(12) Patent Application Publication
(10) Pub. No.: US 2005/0053112 A1
(43) Pub. Date: Mar. 10, 2005

(54) Surface emitting dfb laser structures for broadband communication systems and array of same

(76) Inventor: Ali M Shams-Zadeh-Amiri, North York (CA)

Correspondence Address: HOFFMANN & BARON, LLP, 6900 JERICHO TURNPIKE, SYOSSET, NY, 11791, US

(21) Appl. No.: 10/495,723

(22) PCT Filed: Nov. 15, 2002
(86) PCT No.: PCT/CA02/01746

(30) Foreign Application Priority Data
Nov. 16, 2001 (CA) 2,363,149

(51) Int. Cl. H01S 3/08

(52) U.S. Cl. 372/96; 372/102

(57) ABSTRACT

A surface emitting semiconductor laser (10) is shown having a semiconductor lasing structure having an active layer (22), opposed cladding layers contiguous to said active layer, a substrate (17), and electrodes (12,14) by which current can be injected into the semiconductor lasing structure. Also included is a second or higher order distributed diffraction grating (24) having periodically alternating elements, each of the elements being characterized as being either a high gain element (26) or a low gain element (28). Each of the elements has a length, the length of the high gain element and the length of the low gain element together defining a grating period, where the grating period is in the range required to produce an optical signal in the optical telecommunications signal band. The total length of the high gain elements is no more than the total the lengths of the low gain elements. A single laser structure may be provided or an array of side by side laser structures on a common substrate is also provided. In a further aspect a method of testing laser structures on wafer is provided.

### FIELD OF THE INVENTION

This invention relates generally to the field of telecommunications and in particular to optical signal based telecommunication systems. Most particularly, this invention relates to lasers, such as semiconductor diode lasers, for generating carrier signals for such optical telecommunication systems.

### BACKGROUND OF THE INVENTION

Optical telecommunications systems are rapidly evolving and improving. In such systems individual optical carrier signals are generated, and then modulated to carry information. The individual signals are then multiplexed together to form dense wavelength division multiplexed (DWDM) signals. Improvements in optical technology have led to closer spacing of individual signal channels, such that it is now common for 40 signal channels to be simultaneously deployed in the C-band, with 80 or even 160 simultaneous signal channels in the combined C+L bands beginning to be deployed in the near future.

Each signal channel requires an optical signal carrier source and in telecommunications the signal carrier source is typically a laser. As the number of DWDM signal channels increases, the number of signal carrier sources needed also increases. Further, as optical networks push outward from the data-dense long haul backbones to the data-light edge or end user connections, a vast number of new network nodes are needed, potentially each with the multiple signal carrier sources required for DWDM. As well, the cost of supplying signal carrier sources becomes an issue as a function of data traffic since the data density is less, the closer to edge of the network one is. A number of different laser sources are currently available. These include various forms of fixed, switchable or tunable wavelength lasers, such as Fabry-Perot, Distributed Bragg Reflector (DBR), Vertical Cavity Surface Emitting Lasers (VCSEL) and Distributed Feedback (DFB) designs. Currently the most common form of signal carrier source used in telecommunication applications are edge emitting index coupled DFB laser sources, which have good performance in terms of modulation speed, output power, stability, noise and side mode suppression ratio (SMSR). In addition, by selecting an appropriate semiconductor material and laser design, communication wavelengths can be readily produced. In this sense SMSR refers to the property of DFB lasers to have two low threshold longitudinal modes having different wavelengths at which lasing can occur, of which one is typically desired and the other is not. SMSR comprises a measure of the degree to which the undesired mode is suppressed, thus causing more power to be diverted into the preferred mode, while also having the effect of reducing cross-talk from the undesired mode emitting power at the wavelength of another DWDM channel. A drawback of edge emitting DFB laser signal sources is that the beam shape is in the form of a short stripe, strongly diverging in two dimensions with differing divergence angles due to the small aperture of the emitting area, which requires a spot converter to couple the signal to a single mode fibre. The necessary techniques are difficult and can be lossy, resulting in increased cost.

Although they can achieve good performance once finished and coupled to the fibre, edge emitting DFB lasers have several fundamental characteristics that make them inefficient to produce and hence more expensive. More specifically, large numbers of edge emitting DFB lasers are currently produced simultaneously on a single wafer. However, the yield of viable edge emitting DFB lasers (i.e. those which meet the desired signal output specifications) obtained from a given wafer can be low due to a number of factors in the final fabrication or packaging steps. Specifically, once formed, the individual DFB laser must be cleaved off the wafer. The cleaving step is then followed by an end-finishing step, most usually the application of an anti-reflective coating to one end and a high-reflective coating to the other. If symmetric coatings (usually anti-reflective) are applied to both surfaces, then the two main modes of the laser are degenerate and there no a priori discrimination between modes, leading to poor control of the SMSR and therefore poor single mode yield. The asymmetry introduced by different end coatings helps to give preference to one mode over the other, thus improving the SMSR. However, even though single mode operation is improved, the wavelength of the DFB laser is still a function of the phase of the grating where it was cleaved at the end of the laser cavity. Uncertainty in the phase introduced by the cleaving step results in poor control of the lasing wavelength. Therefore lasers produced in this way generally have poor single mode yield, wavelength yield, or both and are not optimal for use in DWDM systems.

An important aspect of the fabrication of edge emitting DFB lasers is that the laser can only be tested by injecting a current into the lasing cavity after the laser has been completely finished, including cleaving from the wafer and end-coating. This compounds the inefficiency of such low yields from the wafer due to multimode behaviour (poor SMSR) or incorrect wavelength.

Designs intended to increase the yield of single mode edge emitting DFB lasers have been proposed, most notably by introducing a quarter wavelength phase shift in the centre of the laser cavity combined with anti reflection coating both facets of the cavity. This structure suffers from spatial hole burning as a result of the intense field generated in the region of the phase shift. This limits the output power of the device. Further, the laser is very sensitive to even small reflections from the facets, adding a source of instability and difficulty due to the need for high quality anti-reflection coatings on the facets.

Other methods for lifting the degeneracy of the modes in DFB lasers involve introducing an imaginary, or complex, term to the coupling coefficient. One way this has been achieved is to fabricate the grating within either the active gain layer (a so-called gain-coupled design) or within an absorbing layer that is within the optical mode field (a loss-coupled design). These designs have only recently been practical due to advances in the required semiconductor fabrication techniques. Both gain and loss coupled DFB lasers exhibit a significantly reduced sensitivity to the random phase induced by the cleaving step as well as other benefits including high single mode yield, narrower linewidth, and improved ac response (i.e. they can be modulated at higher frequencies). Gain and loss coupled designs still, however, require cleaving and coating of the facets before the chip can be tested. As well, the emission is still from the edge and coupling into a fibre remains a problem.

Both surface emission and single mode operation through complex coupling have been achieved by using a second or higher order grating instead of the more common first order grating. In the case of a second order grating, the resulting radiation loss from the surface of the laser is different for the two modes, thus lifting the degeneracy and resulting in single mode operation, as described by R. Kazarinov and C. H. Henry in IEEE, J. Quantum Electron., vol. QE-21, pp. 144-150, February 1985. With an index coupled second order grating, the spatial profile of the lasing mode is dual-lobed with a minimum at the centre of the laser cavity. The suppressed mode in this instance is a single-lobed Gaussian-like profile peaked at the centre of the cavity. Note that the profile is Gaussian-like in both directions but is asymmetric in that the Gaussian width is in general much larger along the axis of the laser as compared to the Gaussian width transverse to the laser. This latter mode, while being beneficial to most applications, is perhaps even more critical in the field of telecommunications because it more closely matches the mode diameter and numerical aperture of a single mode optical fibre and can therefore be efficiently coupled into the fibre. The dual-lobed shape can only be coupled to a fibre with poor efficiency.

Attempts have been made in the art to alter the laser such that the single-lobed mode of surface emitting DFB lasers becomes the dominant mode, but without much success. For example, U.S. Pat. No. 5,970,081 teaches a surface emitting, index coupled, second order grating DFB laser structure that introduces a phase shift into the laser cavity by means of constricting the shape of the wave guide cavity structure in the middle such that the lasing mode is the preferred approximately Gaussian mode. This method is difficult to implement due to the lithography involved and the design leads to a deterioration of other specifications related to an increase in spatial hole burning in the region of the phase shift. Furthermore, the lower efficiency of the radiation coupling and low coupling coefficient of the index-coupled versus the gain coupled design lead to a low power from the surface as well as relatively high threshold current for the device.

Similarly, U.S. Pat. No. 4,958,357 directly introduces a phase shift in a surface emitting, index coupled, second order grating DFB laser with similar difficulties resulting. While purporting to offer wafer-evaluation and an elimination of facet-cleaving due to surface emission, this patent teaches a complex structure which is difficult to build and even more difficult to control. Due to a cusp in the optical intensity at the location of the phase shift spatial hole burning results. While various schemes are proposed to mitigate spatial hole burning these add complexity and in any event are not successful. Thus, scale-up is limited by spatial hole burning.

Outside of the telecommunications field, an example of a surface emitting DFB laser structure is found in U.S. Pat. No. 5,727,013. This patent teaches a single lobed surface emitting DFB laser for producing blue/green light where the second order grating is written in an absorbing layer within the structure or directly in the gain layer. While interesting, this patent does not disclose how the grating affects fibre coupling efficiency (since it is not concerned with any telecom applications). This patent also fails to teach what parameters control the balance between total output power and fibre coupling efficiency or how to effectively control the mode. Lastly, this patent fails to teach a surface emitting laser which is suitable for telecommunication wavelength ranges.

More recently, attempts have been made to introduce vertical cavity surface emitting lasers (VCSELs) with performance suitable for the telecommunications field. Such attempts have been unsuccessful for a number of reasons. Such devices tend to suffer from a difficulty in fabrication due to the many layered structure required as well as a low power output due to the very short length of gain medium in the cavity. The short cavity is also a source of higher noise and broader linewidth. The broader linewidth limits the transmission distance of the signal from these sources due to dispersion effects in the fibre.

### SUMMARY OF THE INVENTION

What is needed is a surface emitting laser structure which is both suitable for telecommunications applications and which avoids the defects of the prior art. More particularly what is needed is a laser structure where the mode is controlled precisely and efficiently to permit fibre coupling and yet which can be made using conventional lithographic techniques in the semiconductor art. An object of the present invention is to provide a low-cost optical signal source that is capable of generating signals suitable for use in the optical broadband telecommunications signal range. Most preferably such a signal source would be in the form of a semiconductor laser which can be fabricated using conventional semiconductor manufacturing techniques and yet which would have higher yields than current techniques and thus can be produced at a lower cost. It is a further object of the present invention that such a signal source would have enough power, wavelength stability and precision for broadband communications applications. What is also desired is a semiconductor laser signal source having a signal output which is easily and efficiently coupled to an optical fibre. Such a device would also preferably be fabricated as an array on a single wafer-based structure and may be integrally and simultaneously formed or fabricated with adjacent structures such as signal absorbing adjoining regions and photodetector devices.

A further feature of the present invention relates to efficiencies in manufacturing. The larger the number of arrayed signal sources the greater the need for a low fault rate fabrication. Thus, for example, a forty source array fabricated at a yield of 98% per source will produce an array fabrication yield of only 45%. Thus, improved fabrication yields are important to cost efficient array fabrication.

A further aspect of the invention is that each laser source of the array can be set to the same or, more usefully, to different wavelengths and most preferably to wavelengths within the telecommunications signal bands. Most preferably such a device would also provide a simple and effective means to confine the output signal to also help the fibre coupling efficiencies. Further such a device could have a built in detector that, in conjunction with an external feedback circuit, could be used for fine wavelength tuning and signal maintenance.

Therefore according to a first aspect of the present invention there is provided a surface emitting semiconductor laser comprising:

a semiconductor lasing structure having an active layer, opposed cladding layers contiguous to said active layer, a substrate, a refractive index structure to laterally confine an optical mode volume and electrodes by which current can be injected into said semiconductor lasing structure, and

a second order distributed diffraction grating having periodically alternating grating elements, each of said grating elements being characterized as being either a high gain element or a low gain element, where the low gain element may exhibit low gain as compared to the high gain element, no gain or absorption, each of said grating elements having a length, the length of the high gain element and the length of the low gain element together defining a grating period, said grating period being in the range required to produce an optical signal in the wavelength band of optical telecommunications signals, wherein the length of the high gain grating element is no more than 0.5 times the length of the grating period.

According to a second aspect of the present invention there is also provided a method of fabricating semiconductor lasers, said method comprising the steps of:

forming a plurality of semiconductor laser structures by forming, in successive layers on a substrate;

a first cladding layer, an active layer and a second cladding layer on a wafer;

forming a plurality of second order distributed diffraction gratings on said wafer;

forming electrodes on said wafer for injecting current into each of said gratings; and

testing said semiconductor structures by injecting current into said structures in said wafer form.

According to a third aspect of the present invention there is also provided a surface emitting semiconductor laser for producing output signals of defined spatial characteristics said laser comprising;

a semiconductor lasing structure having an active layer, opposed cladding layers contiguous to said active layer, a substrate and electrodes by which current can be injected into said semiconductor lasing structure to produce an output signal in a telecommunications band and a second order distributed diffraction grating sized and shaped to provide, upon the injection of current into the lasing structure, a lower gain threshold to a single lobed mode than the gain threshold provided to any other mode wherein said single lobe mode lases to facilitate coupling said output signal to an optical fibre.

### BRIEF DESCRIPTION OF THE DRAWINGS

Reference will now be made, by way of example only,.to preferred embodiments of the present invention by reference to the attached figures, in which:

FIG. 1 is a side view of one embodiment of a surface emitting semiconductor laser according to the present invention having a second order grating formed in a gain medium;

FIG. 2 is an end view of the embodiment of FIG. 1;

FIG. 3 is a schematic plot of the gain coupling coefficient K_{g}, radiation coupling coefficient Kᵣ, index coupling coefficient Kᵢ, the imaginary part of the total coupling coefficient K_{g}+Kᵣ, and the coupling strength (K_{g}+Kᵣ)/Kᵢ vs. the duty cycle of a high gain element as compared to the grating period;

FIG. 4 is a side view of a second embodiment of a surface emitting semiconductor laser according to the present invention having a second order grating formed in an absorbing or loss layer;

FIG. 5 is an end view of the embodiment of FIG. 4;

FIG. 6 is a schematic plot of mode 1 and mode 2 profiles of optical near-field intensity vs. distance along the laser cavity;

FIG. 7 is a top view of a further embodiment of the present invention showing termination regions in the form of absorbing regions at either end of a laser cavity;

FIG. 8 is top view of a further embodiment of the invention of FIG. 7 wherein one of said termination regions is a detector;

FIG. 9 is a top view of a further embodiment of the present invention wherein the termination regions include first order grating sections; and

FIG. 10 is top view of an array of surface emitting semiconductor laser structures on a common substrate for generating wavelengths 1 to N.

### DETAILED DESCRIPTION OF THE PREFERRED EMBODIMENTS

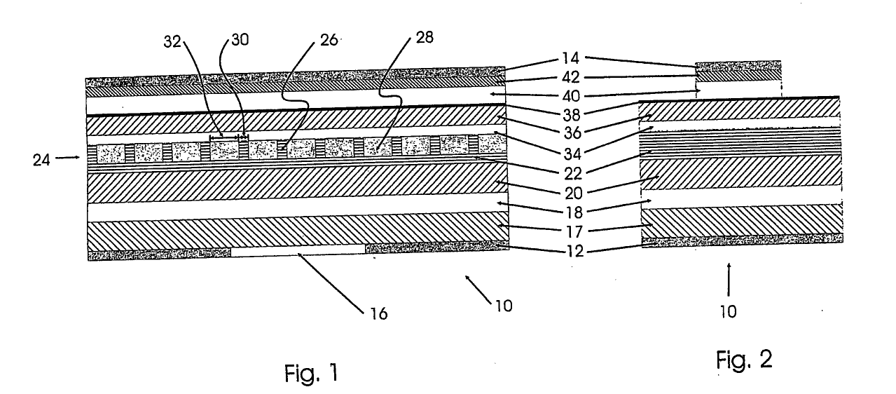

FIG. 1 is a side view of one embodiment of a surface emitting semiconductor laser structure 10 according to the present invention, while FIG. 2 is an end view of the same structure. The laser structure 10 is comprised of a number of layers built up one upon the other using, for example, standard semiconductor fabrication techniques. It will be appreciated that the use of such known semiconductor fabrication techniques for the present invention means that the present invention may be fabricated efficiently in large numbers without any new manufacturing techniques being required.

In this disclosure the following terms shall have the following meanings. A p-region of a semiconductor is a region doped with electron acceptors in which holes (vacancies in the valence band) are the dominant current carriers. An n-region is a region of a semiconductor doped so that it has an excess of electrons as current carriers. An output signal means any optical signal which is produced by the semiconductor laser of the present invention. The mode volume means the volume in which the optical mode exists, namely, where there is light (signal) intensity. For the purposes of this disclosure, a distributed diffraction grating is one in which the grating is associated with the active gain length or absorbing length of the lasing cavity so that feedback from the grating causes interference effects that allow oscillation or lasing only at certain wavelengths, which the interference reinforces.

The diffraction grating of the present invention is comprised of grating or grid elements, which create alternating gain effects. Two adjacent grating elements define a grating period. The alternating gain effects are such that a difference in gain arises in respect of the adjacent grating elements with one being a relatively high gain effect and the next one being a relatively low gain effect. The present invention comprehends that the relatively low gain effect may be a small but positive gain value, may be no actual gain or may be an absorbing or negative value. Thus, the present invention comprehends any absolute values of gain effect in respect of the grating elements, provided the relative difference in gain effect is enough between the adjacent grating elements to set up the interference effects of lasing at only certain wavelengths. The present invention comprehends any form of grating that can establish the alternating gain effects described above, including loss coupled and gain coupled gratings and carrier blocking gratings whether in the active region or not.

The overall effect of a diffraction grating according to the present invention may be defined as being to limit laser oscillation to either one or both of two longitudinal lasing modes, with various additional techniques being employed to further design the laser such that only a single longitudinal mode is stable, giving the laser a narrow line width which may be referred to as a single-mode output signal.

As shown in FIG. 1, the two outside layers 12 and 14 of the laser structure 10 are electrodes. The purpose of the electrodes is to be able to inject current into the laser structure 10. It will be noted that electrode 12 includes an opening 16. The opening 16 permits the optical output signal to pass outward from the laser structure 10, as described in more detail below. According to the present invention, the opening can also be formed on the opposite electrode 14. As well, although a ridge waveguide device is shown, the present invention comprehends other waveguide structures such as, for example, a buried heterostructure. Although an opening is shown, the present invention comprehends the use of a continuous electrode, providing the same is made transparent, at least in part, so as to permit the signal generated to pass out of the laser structure 10. Simple metal electrodes, having an opening 16, have been found to provide reasonable results and are preferred due to ease of fabrication and low cost.

Adjacent to the electrode 12 is an n+InP substrate, or wafer 17. Adjacent to the substrate 17 is a buffer layer 18 which is preferably comprised of n−InP. The next layer is a confinement layer 20 formed from n−InGaAsP. The generic composition of this and other quaternary layers is of the form InₓGa₁₋ₓAs_{y}P_{1-y} while ternary layers have the generic composition In₁₋ₓGaₓAs. The next layer is an active layer 22 made up of alternating thin layers of active quantum wells and barriers, both comprised of InGaAsP or InGaAs. As will be appreciated by those skilled in the art InGaAsP or InGaAs is a preferred semiconductor because these semiconductors, within certain ranges of composition, are capable of exhibiting optical gain at wavelengths in the range of 1200 nm to 1700 nm or higher, which comprehends the broadband optical spectra of the 1300 nm band (1270-1330 nm), the S-band (1468-1525 nm), the C-band (1525 nm to 1565 nm) and the L-band (1568 to 1610 nm). Other semiconductor materials, for example GaInNAs, InGaAlAs are also comprehended by the present invention, provided the output signal generated falls within the broadband range. Other relevant wavelength ranges of telecommunications importance for which devices following this invention could be designed using appropriate material compositions (for example InGaAs/GaAs) are the region from 910 to 990 nm (which corresponds to the most commonly encountered wavelength range for pumping optical amplifiers and fibre lasers based on Er, Yb or Yb/Er doped materials) and near 850 nm (commonly used for short range data transmission). In the embodiment of FIG. 1, a diffraction grating 24 is formed in the active layer 22. The grating 24 is comprised of alternating high gain portions 26 and low gain portions 28. Most preferably, the grating 24 is a regular grating, namely has a consistent period across the grating, and is sized, shaped and positioned in the laser 10 to comprise a distributed diffraction grating as explained above. In this case, the period of the grating 24 is defined by the sum of a length 30 of one high gain portion 26 and a length 32 of the adjacent low gain portion 28. The low gain portion 28 exhibits low or no gain as compared to the high gain portion as in this region most or all of the active structure has been removed. According to the present invention, the grating 24 is a second order grating, namely, a grating with a period equal to the wavelength of the desired wavelength in the semiconductor medium, which results in output signals in the form of surface emission. Higher order gratings also display surface emission, but with more beams at different angles from higher orders, thus decreaseing efficiency into the desired output beam. As can now be appreciated, since the grating 24 of this embodiment is formed in the active gain layer it is referred to as a gain coupled design.

The next layer above the grating 24 is a p−InGaAsP confinement layer 34. Located above the confinement layer 34 is a p−InP buffer region 36. Located above layer 36 is a p−InGaAsP etch stop layer 38. Then, a p−InP cladding layer 40 is provided surmounted by a p⁺⁺-InGaAs cap layer 42.

It will be understood by those skilled in the art that a semiconductor laser built with the layers configured as described above can be tuned to produce an output signal of a predetermined wavelength as the distributed feedback from the diffraction grating written in the active layer renders the laser a single mode laser. The precise wavelength of the output signal will be a function of a number of variables, which are in turn interrelated and related to other variables of the laser structure in a complex way. For example, some of the variables affecting the output signal wavelength include the period of the grating, the index of refraction of the active, confinement, and cladding layers (which in turn typically change with temperature as well as injection current), the composition of the active regions (which affects the layer strain, gain wavelength, and index), and the thickness of the various layers that are described above. Another important variable is the amount of current injected into the structure through the electrodes. Thus, according to the present invention by manipulating these variables a laser structure can be built which has an output with a predetermined and highly specific output wavelength. Such a laser is useful in the communications industry where signal sources for the individual channels or signal components which make up the DWDM spectrum are desired. Thus the present invention comprehends various combinations of layer thickness, gain period, injection current and the like, which in combination yield an output signal having a power, wavelength and bandwidth suitable for telecommunications applications.

However, merely obtaining the desired wavelength and bandwidth is not enough. A more difficult problem solved by the present invention is to produce the specific wavelength desired from a second order grating (and thus, as a surface emission) in such a manner that it can be controlled for efficient coupling, for example, to an optical fibre. The spatial characteristics of the output signal have a big effect on the coupling efficiency, with the ideal shape being a single mode, single-lobed Gaussian. For surface emitting semiconductor lasers the two primary modes include a divergent dual-lobed mode, and a single-lobed mode. The former is very difficult to couple to a single mode fibre as is necessary for most telecommunications applications because the fibre has a single Gaussian mode. Conversely, the single lobed mode of the laser is considerably easier and more efficient to couple to a fibre, since the peak of the energy intensity is located centrally and it much more closely has the shape of the fibre mode. According to the present invention a surface emitting laser structure can be built in which the preferred mode reliably dominates.

As noted above, SMSR refers to the suppression of the unwanted mode in favour of the wanted mode(s). According to the present invention, to achieve good SMSR operation from the surface of the laser 10 requires careful attention to the design of the duty cycle of the grating 24 and thus to the spatial modulation of the gain through the active layer 22. In this description, the term duty cycle means the fraction of the length of one grating period that exhibits high gain as compared to the grating period. In more simple terms, the duty cycle may be defined as the portion of the period of the grating 24 that exhibits high gain. This parameter of duty cycle is controlled in gain coupled lasers, such as illustrated in FIG. 1, by etching away portions of the active layers, with the remaining active layer portion being the duty cycle. Alternatively, the active gain layers can be left intact and the grating can be etched into a current blocking layer, with the fraction of current blocking layer etched away corresponding to the duty cycle.

In FIG. 1, it can now be understood that the second order distributed diffraction grating is written by etching the gain medium to form the grating 24. As a result, the two fundamental modes of the semiconductor laser 10 exhibit different surface radiation losses (which is the output of the laser) and therefore have very different gains. Only one mode (the mode with the lowest gain threshold) will lase, resulting in good SMSR. The present invention comprehends that the desired lasing mode is the single lobed mode that has a profile which is generally Gaussian in appearance. In this way the lasing mode can be easily coupled to a fibre, since the profile of the power or signal intensity facilitates coupling the output signal to a fibre.

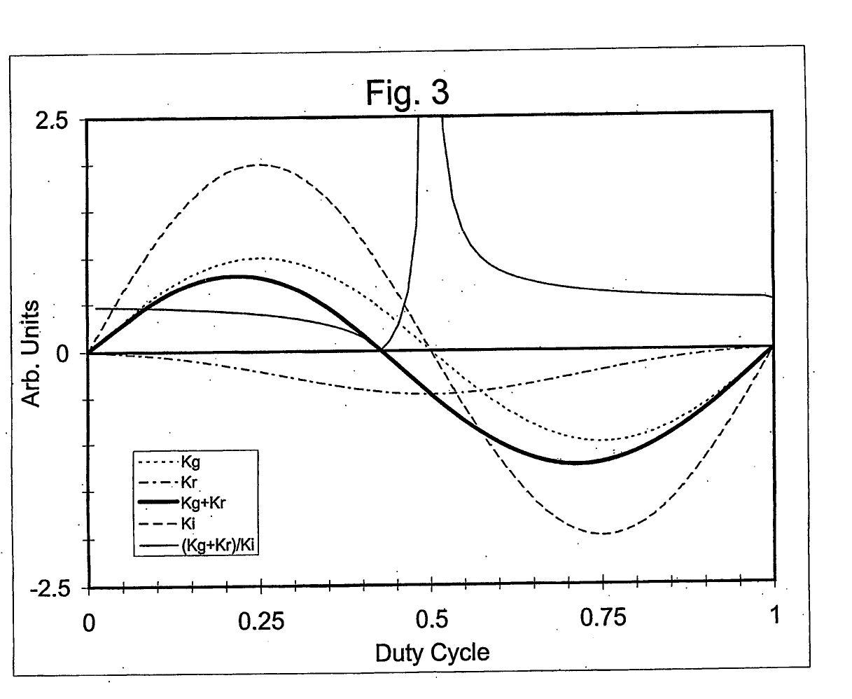

To have the desired single-lobed mode as the single lasing mode according to the present invention, it is important to limit the duty cycle to a specific range of values. The reason for this is explained with reference to FIG. 3, which shows the dependence of the gain, radiation and index coupling coefficients (K_{g}, Kᵣ, and Kᵢ respectively), the imaginary part of the total coupling coefficient (K_{g}+Kᵣ) and the coupling strength ((K_{g}+Kᵣ)/Kᵢ), as a function of the duty cycle of the high gain portion of a distributed second order diffraction grating. Note the total coupling coefficient is defined as Kᵢ+j(K_{g}+Kᵣ), where here j is (−1)^{½}. The important features to note are that the index and gain coupling coefficients are sinusoidal while the radiation coupling coefficient is Gaussian-like and negative. The total coupling coefficient, taken with the cavity losses Kₜ=K+i(K_{g}+Kᵣ) has as the imaginary part K_{g}+Kᵣ while the coupling strength (K_{g}+Kᵣ)/Kᵢ is a measure of the imaginary to the real part of the total coupling coefficient. The real part of the total coupling coefficient (Kᵢ), taken with the effective cavity losses, largely determines the gain threshold while the coupling strength is a good indication of the degree of discrimination between the two fundamental modes since the imaginary part of the total coupling coefficient favours one mode over the other while the real part (Kᵢ) does not discriminate between the two.

Of the two fundamental modes of the laser, the one that will lase will be the one with the lowest gain threshold. Referring to the curves in FIG. 3 for the case of a second order gain coupled laser design as described above, when K_{g}+Kᵣ is positive the single-lobed mode will have the lowest gain threshold while the dual-lobed mode will have a lower threshold when the value is negative. Since Kr is negative, the sum K_{g}+Kᵣ will always be negative for values of duty cycle above 0.5. The cross-over point will always be less than 0.5, only approaching 0.5 when K_{g}>>Kᵣ. Therefore the upper limit to duty cycle to achieve desired operation is 0.5. The mode discrimination is enhanced for larger values of K_{g}+Kᵣ, showing that optimal values of duty cycle are near 0.25. It can be seen that the coupling strength over this region of duty cycles is relatively flat and therefore is not a major factor provided the value is sufficiently large. Another issue that must be considered in a final design is that with the lowering of the duty cycle there is less gain material present and so higher material gains are required as the duty cycle is lowered. This situation pushes optimal duty cycles to be as large as possible to alleviate the requirements on material gain. Taken all together, this invention comprehends a useful region of duty cycle to be between about 15% and 35%.

In addition to the mode discrimination (SMSR) due to design of the laser cavity, we also consider the contribution to SMSR due to the fibre coupling step. Since only the generally Gaussian mode is easily coupled to a fibre, a significant improvement in SMSR can be realized with the power of the other mode not being coupled to the fibre. Taken together with the high discrimination between modes due to the cavity design, the overall SMSR of the laser is excellent.

Turning to FIG. 2, a side-view of the laser structure of FIG. 1 is shown. As can be seen in FIG. 2, the electrodes 12 and 14 permit the application of a voltage across the semiconductor laser structure 10 to encourage lasing as described above. Further, it can be seen that the ridge formed by the top layers serves to confine the optical mode laterally to within the region through which current is being injected. While a ridge waveguide is shown in this embodiment it is comprehended that a similar structure could be fabricated using a buried heterostructure sized and shaped to confine the carriers and optical field laterally.

Other forms of gain coupled designs are comprehended as a means to implement the present invention. For example instead of etching the active region as described above, a further highly n-doped layer can be deposited above the active layer and a grating can be made in this layer. This layer would then be not active optically and thus neither absorbs nor exhibits gain. Instead, it blocks charge carriers from being injected into the active layer wherever it has not been etched away. This structure for an edge emitting gain coupled laser is taught in C. Kazmierski, R. Robein, D. Mathoorasing, A. Ougazzaden, and M. Filoche, IEEE, J. Select Topics Quantum Electron., vol. 1, pp. 371-374, June 1995. The present invention, comprehends modifying such a structure to limit the carrier blocking layer to having openings in it with a duty cycle of less than 0.5 preferably in the range of 0.15 to 0.35 and most preferably about 0.25 (i.e. about 0.75 blocking).

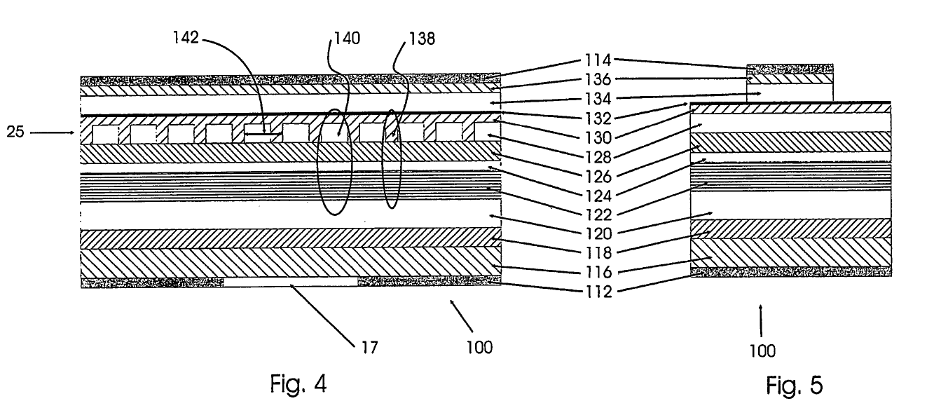

Turning to FIG. 4, a further embodiment of a surface emitting semiconductor laser structure 100 is shown. In this embodiment, electrodes 112 and 114 are provided at the top and bottom. Adjacent to the electrode 112 is an n+InP substrate 116 followed by a n—InP buffer 118. An opening 117 is provided in electrode 112. Again, the opening could also be in the opposite electrode 114. A first confinement n−InGaAsP layer 120 is provided above which is located an active region 122 comprised of InGaAsP or InGaAs quantum well layers separated by InGaAsP or InGaAs barrier layers. Then, a p−InGaAsP confinement region 124 is provided with a p−InP buffer region 126 there-above. A grating 125 is formed in the next layer, which is a p− or n−InGaAs or InGaAsP absorption layer 128. A further p−InP buffer layer 130 is followed by a p−InGaAsP etch stop layer 132. Then, a p−InP cladding layer 134 is provided along with a p⁺⁺-InGaAs cap layer 136 below the electrode 114. As will now be appreciated, this embodiment represents a second (or higher) order grating which is formed by providing an absorbing layer and etching or otherwise removing the same to form a loss coupled device. The grating 125 is comprised of a periodically reoccurring loss or absorption elements. When taken together with the continuous gain layer 122 (even though the gain layer is not on the same level as the absorption layer) this grating 125 can be viewed as a grating having periodically repeating high gain elements 138 and low gain (which may be no gain or even net loss) elements 140. The combination of any one high gain element 138 and one low gain element 140 defines a period 142 for said grating 125.

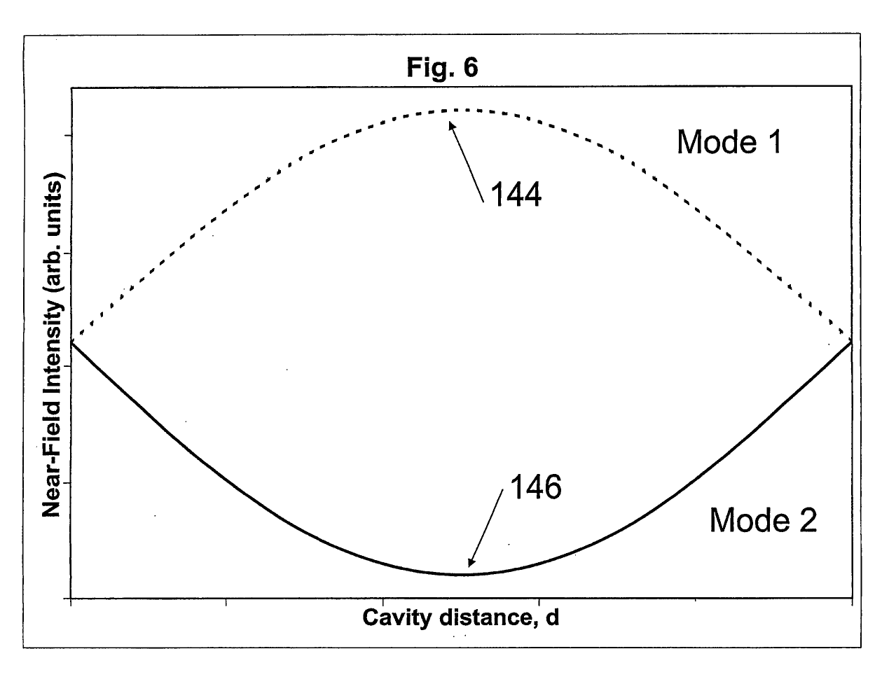

FIG. 5 shows the semiconductor laser structure of FIG. 4 in end view. As can be noted, a current can be injected through the electrodes 112 and 114 to the semiconductor laser structure 100 for the purpose of causing lasing in as described above. As in FIG. 2, the ridge provides the lateral confinement -for the optical field. FIG. 6 is a schematic of an optical near-field intensity versus the distance along the laser cavity, and is generally applicable to both of the previously described embodiments. As shown, at the middle of the laser cavity, the mode 1 (the wanted generally Gaussian shaped) field intensity is at a peak 144, whereas the mode 2 (the unwanted divergent dual lobed) field intensity is at a minimum 146. Thus, at the middle of the laser cavity the optical field is much more intense in the mode 1 or Gaussian profile. This FIG. 6 therefore illustrates the highly effective side mode suppression arising from the controlled duty cycle of the present invention. Further it illustrates the need for the opening 16 in the electrode 12 in the middle of the cavity to let out the signal as shown in FIG. 1. As noted earlier, this opening can be located on either electrode.

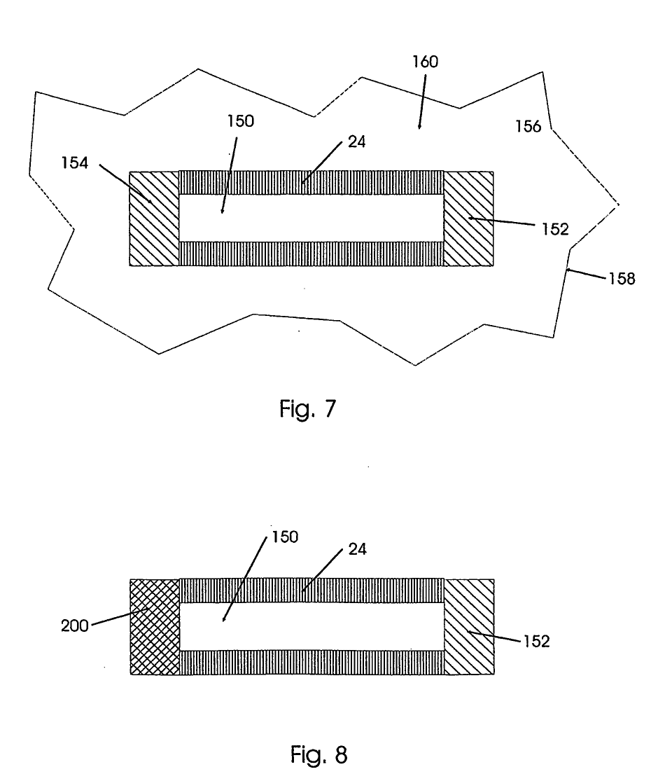

FIG. 7 shows a top view of a further embodiment of the present invention, where the grating region 150 includes finished end portions 152, 154 for improved performance. As can be seen the grating 150 can be written onto a wafer 156 (shown by break line 158) using known techniques. The grating 150 so written can be surrounded by an adjoining region 160 which separates and protects the grating 150. Because the present invention is a surface emitting device, rather than cleaving the grating end portions as in the prior art edge emitting lasers, the present invention contemplates cleaving, to the extent necessary, in the non-active adjoining region 160. Thus, no cutting of the grating 150 occurs during cleaving and the properties of each of the gratings 150 can be specifically designed, predetermined and written according to semiconductor lithographic practices. Thus, each grating can be made with an integral number of grating periods and each adjacent grating on wafer 156 can be written to be identical or different from its neighbours. The only limit of the grating is the writing ability of the semiconductor fabrication techniques. Importantly, unlike the prior art edge emitting semiconductor lasers the grating properties will not change as the laser structures are packaged.

The present invention further comprehends making the grating termination portions 152, 154 absorbing regions. This is easily accomplished by not injecting current into the termination regions as the active layer is absorbing when not pumped by charge injection. As such, these regions will strongly absorb optical energy produced and emitting in the horizontal direction, thus fulfilling the function of the anti-reflective coatings of the prior art without further edge finishing being required. Such absorbing regions can be easily formed as the layers are built up on the wafer during semiconductor manufacturing without requiring any additional steps or materials. In this manner a finishing step required in the prior art is eliminated, making laser structures 10 according to the present invention more cost efficient to produce than the prior art edge emitting lasers. It will therefore be appreciated that the present invention contemplates cleaving (where necessary or desirable) through an adjoining region 160 distant from the actual end of the grating 150 whereby the prior art problems associated with cleaving the grating and thereby introducing an uncontrolled phase shift into the cavity are completely avoided.

A further advantage of the present invention can now be understood. The present invention comprehends a method of manufacturing where there is no need to cleave the individual elements from the wafer, nor is there any need to complete the end finishing or packaging of the laser structure before even beginning to test the laser structures for functionality. For example, referring to FIG. 1, the electrodes 12, 14 are formed into the structure 10 as the structure is built and still in a wafer form. Each of the structures 10 can be electrically isolated from adjacent structures when on wafer, by appropriate patterning and deposition of electrodes on the wafer, leaving high resistance areas in the adjoining regions 160 between gratings as noted above. Therefore, electrical properties of each of the structures can be tested on wafer, before any packaging steps occur, simply by injecting current into each grating structure 150 on wafer. Thus, defective structures can be discarded or rejected before any packaging steps are taken (even before cleaving), meaning that the production of laser structures according to the present invention is much more efficient and thus less expensive than in the prior art where packaging is both more complex and required before any testing can occur. Thus cleaving, packaging and end finishing steps for non-functioning or merely malfunctioning laser structures required in the prior art edge emitting laser manufacture are eliminated by the present invention.

FIG. 8 shows a further embodiment of the present invention including a detector region 200 located at one side of the grating region. The detector region 200 can be made integrally with the laser structure by reverse biasing the layers of the detector region 200 to act as a photodetector. This detector is inherently aligned with the surface emitting laser 10 and is easily integrated by being fabricated at the same time as the laser structure, making it very cost efficient to include. In this way the signal output can be sensed by the detector 200 and the quality of the optical signal, in terms of power stability can be monitored in real time. This monitoring can be used with an external feedback loop to adjust a parameter, for example the injection current, which might be varied to control small fluctuations in the power. Such a feedback system allows the present invention to provide very stable or steady output signals over time, to tune the output signal as required or to compensate for changes in environment such as temperature changes and the like which might otherwise cause the output signal to wander. Variations in an output optical signal can be therefore compensated for by changes in a parameter such as the current injected into the laser. In this way, the present invention contemplates a built-in detector for the purpose of establishing a stable signal source, over a range of conditions, having a stable output power.

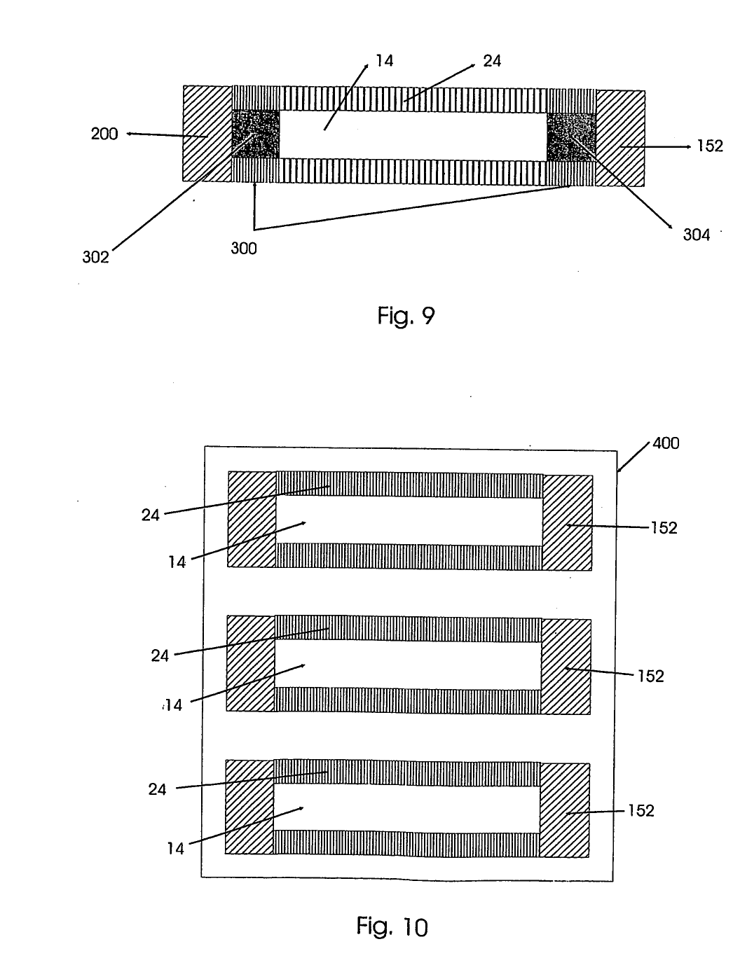

FIG. 9 is a further embodiment of the present invention which includes enhanced confinement of the optical near-field to the central part of the device. While a nominal increase in spatial hole-burning is expected, the offsetting advantage is that the surface emission is more strongly confined in the dimension along the laser cavity, thus achieving closer to cylindrical symmetry. To achieve this result in this embodiment, the central part of the laser structure consists of a second (or higher) order grating with a first order grating 300 added to each end of the second order grating region 24. Separate electrodes 302 and 304 are provided to activate the first order grating region 300. The effect of the adjacent first order grating beside the second order grating is to enhance the confinement of the output signal.

FIG. 10 is a top view of an array of semiconductor laser structures 10 according to the present invention all formed on a single common substrate 400. In this case, each grating 24 can be designed to produce a specific output (specific signal) in terms of wavelength and output power. The present invention contemplates having each of the adjacent signal sources which form the array at the same wavelength or specific signal as well as having each of them at a different wavelength or specific signal. Thus, the present invention contemplates a single array structure which simultaneously delivers a spectrum of individual wavelengths suitable for broadband communications from a plurality of side by side semiconductor laser structures. Each laser structure or signal source may be independently modulated and then multiplexed into a DWDM signal. Although three are shown for ease of illustration, because of the flexibility in design, the array can include from two up to forty or more individual wavelength signal sources on a common substrate 400.

It will be appreciated by those skilled in the art that while reference has been made to preferred embodiments of the present invention various alterations and variations are possible without departing from the spirit of the broad claims attached. Some of these variations have been discussed above and others will be apparent to those skilled in the art. For example, while preferred structures are shown for the layers of the semiconductor laser structure of the invention other structures may also be used which yield acceptable results. Such structures may be either loss coupled or gain coupled as shown. What is believed important is to have a duty cycle in the grating at less than 50% and most preferably close to 25%.

1. A surface emitting semiconductor laser comprising:
a semiconductor lasing structure having an active layer, opposed cladding layers contiguous to said active layer, a substrate, a refractive index structure to laterally confine an optical mode volume and electrodes by which current can be injected into said semiconductor lasing structure, and
a second or higher order distributed diffraction grating having periodically alternating grating elements, each of said grating elements being characterized as being either a high gain element or a low gain element, where, upon current injection, the low gain element exhibits low gain, no gain or absorption as compared to the high gain element, each of said elements having a length, the length of the high gain element and the length of the low gain element together defining a grating period, said grating period being in the range required to produce an optical signal in the optical telecommunications signal band, wherein the length of one of the high gain elements is no more than 0.5 times the length of the grating period.

2. A surface emitting semiconductor laser as claimed in claim 1 wherein the length of said high gain elements is between 15% and 35% of the length of said grating period.

3. A surface emitting semiconductor laser as claimed in claim 1 wherein the length of one of said high gain elements is about 25% of the length of said grating period.

4. A surface emitting semiconductor laser as claimed in claim 1 wherein said distributed diffraction grating is optically active and is formed in a gain medium in the active layer.

5. A surface emitting semiconductor laser as claimed in claim 1 wherein said distributed diffraction grating is optically active and is formed in a loss medium in the mode volume.

6. A surface emitting semiconductor laser as claimed in claim 1 wherein said distributed diffraction grating is not optically active and is formed from a current blocking material.

7. A surface emitting semiconductor laser as claimed in claim 1 wherein said grating comprises an integral number of grating periods.

8. A surface emitting semiconductor laser as claimed in claim 1 wherein said structure further includes an adjoining region at least partially surrounding said grating in plan view.

9. A surface emitting semiconductor laser as claimed in claim 8 wherein said adjoining region further includes integrally formed absorbing regions located at either end of said distributed diffraction grating.

10. A surface emitting semiconductor laser as claimed in claim 1 further including an adjoining region having a photodetector.

11. A surface emitting semiconductor laser as claimed in claim 10 wherein said photodetector is integrally formed with said lasing structure.

12. A surface emitting semiconductor laser as claimed in claim 11 further including a feedback loop connected to said photodetector to compare a detected output signal with a desired output signal.

13. A surface emitting semiconductor laser as claimed in claim 12 further including an adjuster for adjusting an input current to maintain said output signal at a desired characteristic.

14. A surface emitting semiconductor laser as claimed in claim 8 wherein said adjoining region is formed from a material having a resistance sufficient to electrically isolate said grating, when said laser is in use.

15. A surface emitting laser as claimed in claim 1 wherein one of said electrodes includes a signal emitting opening.

16. A surface emitting laser as claimed in claim 1 wherein said laterally confining refractive index structure is one of a ridge waveguide or a buried heterostructure waveguide.

17. A surface emitting semiconductor laser as claimed in claim 8 wherein said laser structure further includes a longitudinal field confinement structure at either end of said laser cavity.

18. A surface emitting semiconductor laser as claimed in claim 17 wherein said longitudinal field confinement structure comprises an integrally formed first order grating, and, said laser further includes second electrodes associated with said first order grating to inject a current therein.

19. An array of surface emitting semiconductor lasers as claimed in claim 1 wherein said array includes two or more of said lasers on a common substrate.

20. An array of surface emitting semiconductor lasers as claimed in claim 19 wherein each of said two or more of said lasers produces an output signal having a different wavelength and output power and can be individually modulated.

21. An array of surface emitting semiconductor lasers as claimed in claim 19 wherein each of said two or more of said lasers produces an output signal having the same wavelength.

22. A method of fabricating surface emitting semiconductor lasers, said method comprising the steps of:
forming a plurality of semiconductor laser structures by forming, in successive layers on a common wafer substrate;
a first cladding layer, an active layer and a second cladding layer on said wafer substrate;
forming a plurality of second or higher order distributed diffraction gratings associated with said active layer on said wafer substrate;
forming electrodes on each of said semiconductor laser structures on said wafer substrate for injecting current into each of said gratings, where one of said electrodes has an aperture to allow light emission; and
testing each of said semiconductor laser structures by injecting a testing current into said structures while the same are still connected to said common wafer substrate.

23. A method of fabricating surface emitting semiconductor lasers as claimed in claim 22 further comprising the step of simultaneously forming adjoining regions between said plurality of distributed diffraction gratings.

24. A method of fabricating surface emitting semiconductor lasers as claimed in claim 22 further including the step of providing a refractive index structure to laterally confine an optical mode of each of said semiconductor laser structures in the form of a ridge waveguide or a buried heterostructure waveguide.

25. A method of fabricating surface emitting semiconductor lasers as claimed in claim 22 further including the step of forming at either end of each of said gratings an absorbing region in said adjoining region.

26. A method of fabricating surface emitting semiconductor lasers as claimed in claim 22 further including the step of cleaving said wafer along said adjoining regions to form an array of lasers.

27. A surface emitting semiconductor laser comprising:
a semiconductor lasing structure having an active layer, opposed cladding layers contiguous to said active layer, a substrate, a refractive index structure to laterally confine an optical mode volume and electrodes by which current can be injected into said semiconductor lasing structure, and
a second or higher order distributed diffraction grating associated with an active layer of said lasing structure, said distributed diffraction grating having periodically alternating grating elements, each of said grating elements having a gain effect wherein any adjacent pair of grating elements includes one element having a relatively high gain effect and one having a relatively low gain effect wherein, a difference in such gain effects, the different refractive indices of the high and low gain elements, and the grating period cause an output signal in the range near 850 nm, or 910 nm to 990 nm, or 1200 nm to 1700 nm and wherein each of said grating elements has a length, the length of the relatively high gain effect element and the length of the relatively low gain effect element together defining a grating period, wherein the length of one of the relatively high gain elements is no more than 0.5 times the length of the grating period.

28. A surface emitting semiconductor laser as claimed in claim 27 wherein said laterally confining refractive index structure is one of a ridge waveguide or a buried heterostructure waveguide.

29. A method of stabilizing an output signal from a laser comprising the steps of:
energizing a surface emitting laser by injecting current into the laser;
energizing one or more associated photodetectors associated with the laser;
monitoring the quality of the output signal from the surface emitting laser with the photodetector; and
adjusting the amount of current injected into the laser to prevent signal wandering.

30. The method of claim 29 further including a pre-step of forming said photodetector integrally with said laser.

31. A method of stabilizing an output signal from a laser as claimed in claim 30 further including the step of connecting said photodetector to a feedback loop and comparing said detected signal output with a desired signal output.

32. A method of stabilizing an output signal from a laser as claimed in claim 31 further including the step of providing an adjuster and adjusting the amount of current injected into said laser to prevent signal wandering in response to said comparison of arising from said feedback loop.

33. A surface emitting semiconductor laser for producing output signals of defined spatial characteristics said laser comprising;
a semiconductor lasing structure having an active layer, opposed cladding layers contiguous to said active layer, a substrate and electrodes by which current can be injected into said semiconductor lasing structure to produce an output signal in a telecommunications band and a second or higher order distributed diffraction grating sized and shaped to provide, upon the injection of current into the lasing structure, a lower gain threshold to a single lobed mode than the gain threshold provided to any other mode wherein said single lobe mode lases to facilitate coupling said output signal to an optical fibre.

34. A surface emitting semiconductor laser for producing output signals of defined spatial characteristics as claimed in claim 33 wherein said distributed diffraction grating is comprised of alternating grating elements which define a grating period, wherein one of said elements is a relatively high gain element and the adjacent element is a relatively low gain element and wherein the length of the relatively high gain element is no more than 0.5 times the length of the grating period.

35. A surface emitting semiconductor laser for producing output signals of defined spatial characteristics as claimed in claim 33 wherein said distributed diffraction grating is a gain coupled grating in an active region of said structure.

36. A surface emitting semiconductor laser for producing output signals of defined spatial characteristics as claimed in claim 33 wherein said distributed diffraction grating is loss coupled grating in the mode volume of said structure.

37. A surface emitting semiconductor laser for producing output signals of defined spatial characteristics as claimed in claim 33 wherein said distributed diffraction grating is a current blocking grating in said semiconductor lasing structure.
